(19) United States
(12) Patent Application Publication
(10) Pub. No.: US 2012/0278402 A1
(43) Pub. Date: Nov. 1, 2012

(54) PRESENTING LINKS TO CONTENT AS ATTACHMENTS IN ELECTRONIC MESSAGES

(75) Inventors: David Paul Limont, Seattle, WA (US); Daniel Paul Costenaro, Bellevue, WA (US); Jedidiah Brown, Seattle, WA (US)

(73) Assignee: MICROSOFT CORPORATION, Redmond, WA (US)

(21) Appl. No.: 13/096,854

(22) Filed: Apr. 28, 2011

(51) Int. Cl. G06F 15/16

(52) U.S. Cl. 709/206

(57) ABSTRACT

A user receiving an electronic message is presented with linked content within an attachment area of the message for easier access than having to locate the link within the body of the message. Links to content that are placed within the body of a message are automatically detected and displayed as an attachment. When a user views the message, the linked content remains in view when scrolling the body of the message. The links may be to any type of content, such as word processing documents, spreadsheets, slides, websites and the like. The linked content may also be automatically downloaded such that the content is available offline.

### BACKGROUND

Users routinely send links to documents and other content to other users for viewing. A user receiving the message finds the link within the message and then selects the link to access the content. Many times, a message thread will contain a large number of responses causing the link that is contained within the message thread difficult to locate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A user receiving an electronic message is presented with linked content within an attachment area of the message for easier access than having to locate the link within the body of the message. Links to content that are placed within the body of a message are automatically detected and displayed as an attachment. When a user views the message, the linked content remains in view when scrolling the body of the message. The links may be to any type of content, such as word processing documents, spreadsheets, slides, websites and the like. The linked content may also be automatically downloaded such that the content is available offline.

### BRIEF DESCRIPTION OF THE DRAWINGS

FIG. 1 illustrates an exemplary computing environment;

FIG. 2 shows a system for presenting links to content as attachments in electronic messages;

FIG. 3 shows a display of an electronic message including a link within a body of an electronic message and access to the linked content within an attachment area;

FIG. 4 shows a display of an electronic message including a link within a body of an electronic message and a link to the same content within an attachment area;

FIG. 5 shows a display of an electronic message including two links to content within a body of an electronic message;

FIG. 6 shows a display of an electronic message including a link to content within a body of an electronic message and an attached document;

FIG. 7 shows a display of an electronic message within a Web browser including a link to content within a body of an electronic message; and

FIG. 8 shows an illustrative process for presenting links to content as attachments in electronic messages.

### DETAILED DESCRIPTION

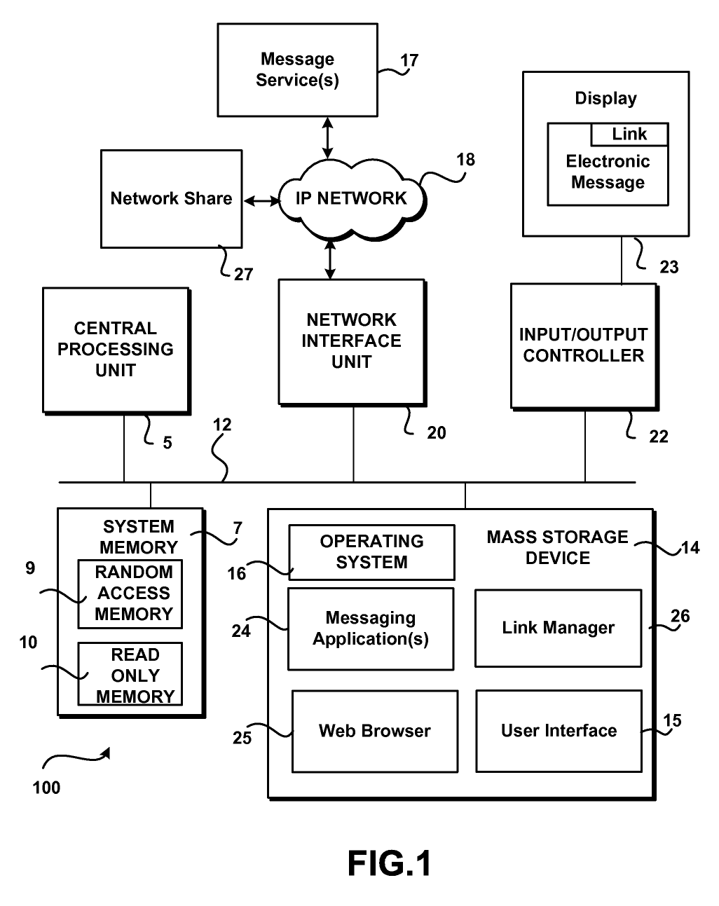

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a mobile computing device (e.g. phone, tablet, net book, laptop), server, a desktop, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, messaging application(s) 24, Web Browser 25, and link manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to a display screen 23, a printer, or other type of output device.

As mentioned briefly above, a number of program modules and data files may be stored in the mass storage device 14 and RAM 9 of the computer 100, including an operating system 16 suitable for controlling the operation of a computer, such as the WINDOWS PHONE 7®, WINDOWS 7®, or WINDOWS SERVER® operating system from MICROSOFT CORPORATION of Redmond, Washington. The mass storage device 14 and RAM 9 may also store one or more program modules. In particular, the mass storage device 14 and the RAM 9 may store one or more application programs, including one or more messaging application(s) 24 and Web browser 25.

A user interface 15 is used by a user to interact with applications and documents. Messaging application(s) 24 may be one or more different messaging applications. For example, computing device 100 may include an email application, an Instant Messaging (IM) application, an SMS, MMS application, a real-time information network (e.g. Twitter® interface), a social networking application, and the like. According to an embodiment, messaging application 24 is an email application, such as MICROSOFT OUTLOOK®. The messaging application(s) may be client based and/or web based. For example, a network based message service 17 may be used, such as: MICROSOFT WINDOWS LIVE or some other network based email and messaging service.

Network share 27 is configured to store content (e.g. documents, spreadsheet, Web content, and the like) that are accessible to one or more users through IP network 18. For example, network share 27 may store content that is accessible by users located at one or more locations.

Link manager 26 is configured to process links within messages and present them as attachments to users. Link manager 26 may be located externally from an application, e.g. messaging application 24, as shown or may be a part of an application. Further, all/some of the functionality provided by link manager 26 may be located internally/externally from a messaging application.

Link manager 26 is configured to present linked content in an attachment area of an electronic message for easier access than having to locate the link within the body of the message. Link manager 26 automatically detects links to content that are placed within the body of a message and displays them within an attachment area. The term “link” refers to an address that represents a location of content. For example, a link may be in the form of a Uniform Resource Locator (URL) that specifies a network location of where the content is stored. Selecting the link generally retrieves the content that is pointed to by the link. When a user views the message, the linked content remains in view when scrolling the body of the message. The links may be to any type of content, such as word processing documents, spreadsheets, slides, websites and the like. The linked content may also be automatically downloaded such that the content is available offline. More details regarding the link manager are disclosed below.

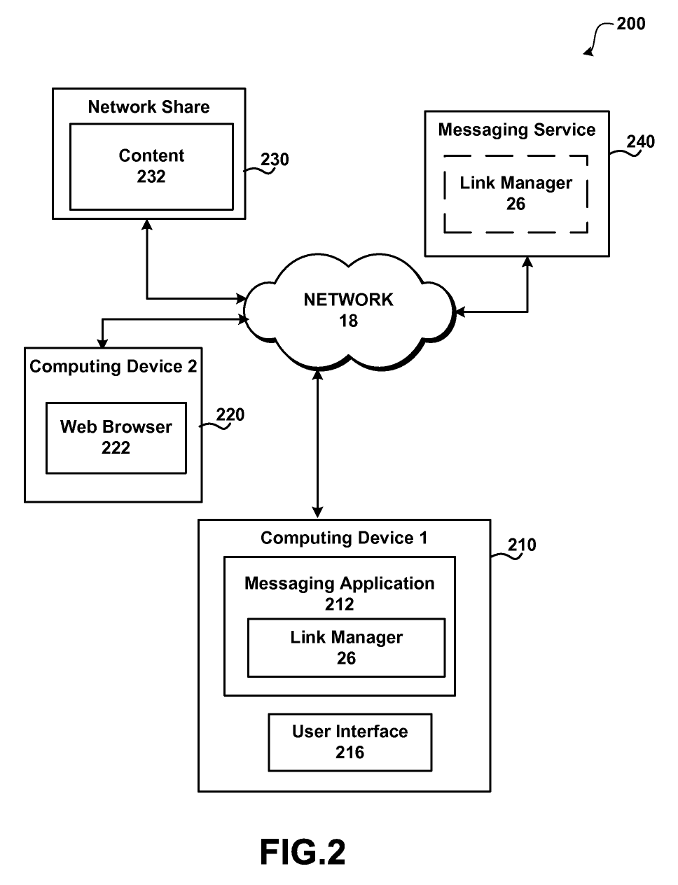

FIG. 2 shows a system for presenting links to content as attachments in electronic messages. As illustrated, system 200 includes computing device 1 (210), computing device 2 (220), network share 230 and messaging service 240.

The computing devices may be any type of computing device that is configured to perform the operations relating to sending and receiving electronic messages that include links to content. For example, some of the computing devices may be: mobile computing devices (e.g. cellular phones, tablets, smart phones, laptops, and the like); desktop computing devices and servers. Some computing devices may be arranged to provide an online service (e.g. messaging service 240 that is configured for sending and receiving electronic messages), some may be arranged as data shares, some may be arranged in local networks, some may be arranged in networks accessible through the Internet, and the like.

The computing devices are coupled through network 18. Network 18 may be many different types of networks. For example, network 18 may be an IP network, a carrier network for cellular communications, and the like. Generally, network 18 is used to transmit data between computing devices, such as computing device 1, computing device 2, network share 230 and messaging service 240.

Computing device 1 includes messaging application 212 and user interface 216. As illustrated, computing device 1 is used by a user to interact with electronic messages, content in a network share (e.g. content 232) and the like.

User interface (UI) 216 is used to interact with an application and content, such as messaging application 212 and content 232. One or more user interfaces of one or more types may be used to interact with the content. For example, UI 216 may include the use of a context menu, a menu within a menu bar, a menu item selected from a ribbon user interface, a graphical menu, and the like. Generally, UI 216 is configured such that a user may easily interact with content and electronic messages. For example, a user may simply select an option within UI 216 that creates new electronic messages that include links to content within the body of the electronic messages. Upon receipt of the message, the user views the linked content that are associated with links that are included within the electronic message within an attachment area. The links to the content within the body of the message may also remain within the body of the message such that a user can access the linked content either from an attachment area and/or from within the body of the message.

Messaging application 212 may be a client based application, such as an email application, an Instant Messaging Application, a social media application, and the like. Generally, messaging application 212 is used to send and receive electronic messages of one or more types. A network based messaging service 240 may be used in addition to messaging application 212 or instead of one or more of the different messaging applications. For example, a web interface may be used to access messaging service 240.

Messaging service 240 may be used to process electronic messages between one or more computing devices, such as computing device 1 and computing device 2. Messaging service 240 may be configured to process different message types, such as SMS, MMS, email, messages for social networks and the like. Messaging service 240 may be configured with the functionality of link manager 26 and one or more message types may be used to communicate the electronic messages including links to content that are within the body of the electronic message.

Computing device 2 includes one or more applications, such as a web browser (222) that may be configured to access a messaging service, such as a web based email service and to interact with content. For example, a web browser may be used to access an electronic message through an email service and then access content 232 stored in network share 230.

One or more network shares (e.g. Network share 230) may be used to store content. The content may be any type of content that is linked within a message, such as word processing documents, spreadsheets, slides, website content and the like Network share 230 is accessible by the computing devices that interact with the content. The network share may be associated with an online service that supports online access/interaction with content.

Link manager 26 is configured to detect any links to content that are included within a body of an electronic message. The links may be to any type of content, such as word processing documents, spreadsheets, slides, website content and the like. Generally, the link may be to any type of content that is accessible by a computing device. Any links to content that are detected within the body of the message are displayed within an attachment area such that when a user receiving the message, the linked content is viewable within an attachment area. The links may be detected before the message is sent and/or after the message is received. Many times a link will not be viewable within the body of the message. For example, the link may be contained within a portion of the message that is out of the current view. In order to access the link within the body of the message, the user scrolls the body of the message to find the link. By presenting the linked content within an attachment area, the linked content is viewable without having to locate the link within the body of the message.

According to an embodiment, content that is linked within the body of the message is automatically downloaded and included within the attachment area before the user receiving the message views the message. The linked content may be obtained before the message is sent and/or after the message is received by the user. For example, upon receipt of the message, the linked content may be automatically downloaded and included with the message. All/some of the linked content may be automatically downloaded. The linked content may be automatically downloaded based on predetermined conditions, such as: the message is from a trusted sender, the size of the linked content is below a size threshold, the link is included within a reply message to the receiver of the message, the message originates from a specified source, and the like.

Link manager 26 is also configured to determine when changes are made offline to the linked content that has been automatically downloaded. When a change has been made to the linked content, link manager 26 synchronizes the changes once the computing device is online and is able to synchronize the changes. For example, the changes may be stored in a cache until the computing device is able to connect to a server storing the content.

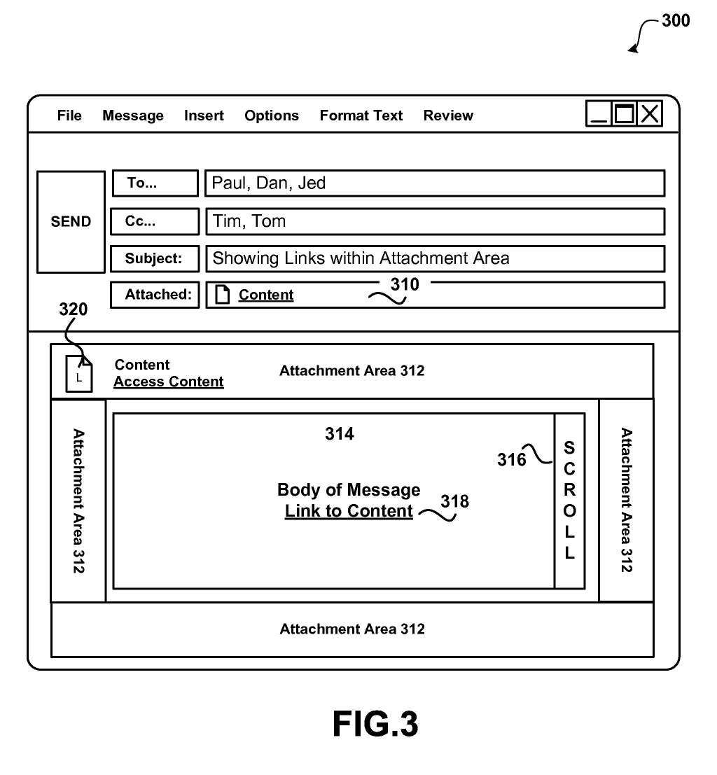

FIGS. 3-7 show exemplary electronic messages including linked content appearing as attachments. FIGS. 3-7 are for exemplary purpose and are not intended to be limiting.

FIG. 3 shows a display of an electronic message including a link within a body of an electronic message and access to the linked content within an attachment area. As illustrated, message 300 comprises a To: field, a Cc: field, a Subject field:, an Attached field:, attachment areas 313, body of the message 314 including a link to content 318 and scroll control 316. More or fewer fields may be included with the electronic message.

The electronic message may be accessed a number of ways. For example, a web browser may access an electronic mail service, an email application on a computing device may be configured to receive emails from one or more different services, and the like.

When electronic message is created, a link to content 318 is included within the body of the message. The links may be to any type of content, such as word processing documents, spreadsheets, slides, websites and the like. Generally, the link may be to any type of content that is accessible by a computing device.

Any links to content that are included within the body of the message are displayed as linked content within an attachment area such that when a user receiving the message accesses the message the linked content is viewable within an attachment area that is associated with the electronic message. In this way, the user does not have to search for the linked content within the body of the electronic message that may contain many different responses. Many times a link will not be viewable within the body of the message. For example, the link may be contained within a portion of the thread that is currently out of view.

The attachment areas may be presented within many different areas of the display. Generally, the attachment area is located such that the display of the attached area remains visible even though the body of the message is scrolled to change the view of the message. For example, the attachment area 312 may be located in a position around the body of the message (e.g. top left corner of the message as illustrated, or in some other location around the message. According to an embodiment, the linked content 310 is displayed within an Attached field below the Subject field. The fields may be displayed in different ways. For example, a Cc field may not be shown, the Attached field may be displayed within another area of display 300, and the like.

A graphical indicator 320, such as an icon, may be displayed within the attachment area. The graphical indicator may be selected to indicate a type of the content and/or other characteristics relating to the linked content. For example, a document icon may be used to show the content is a document, a web icon may be used for web content, a spreadsheet icon may be used for spreadsheets, a picture icon may be used for pictures, a message icon may be used for messages, and the like. An indicator may also be displayed that shows that the icon represents content that is linked within the body of the message. For example, an “L” within the icon may be used to show that the content is linked within the body of the message. Other indicators may also be used to show other information (e.g. an indicator to show that the linked content has been downloaded).

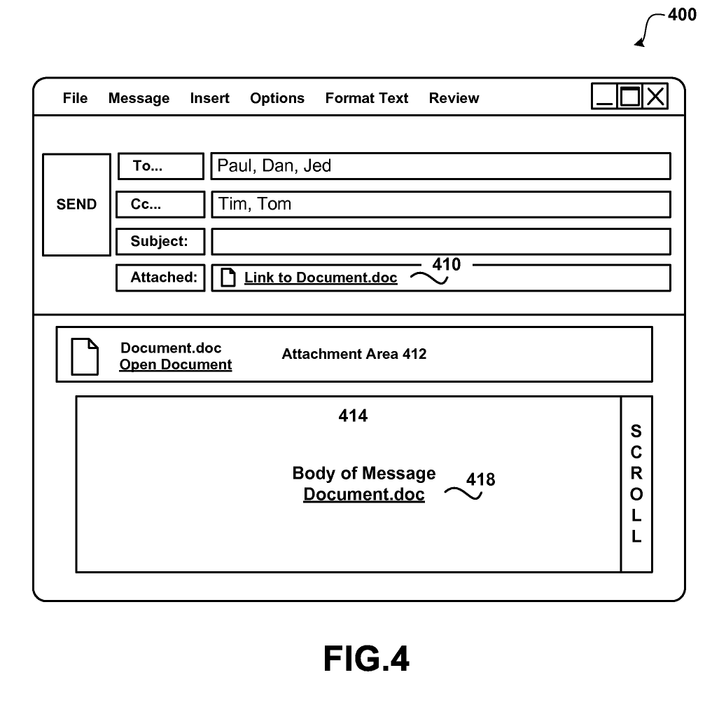

FIG. 4 shows a display of an electronic message including a link within a body of an electronic message and a link to the same content within an attachment area. As illustrated, message 400 shows a link 418 to a document (Document.doc) within the body of the message 414. A link is displayed within an attachment area 412 and Attached field 410 that may be used to access the linked content. In the current example, the linked content is not automatically downloaded. While a link to the content is shown in both the Attached field 410 and the attachment area 412, a link to the content (Document.doc) may me included in more or fewer locations.

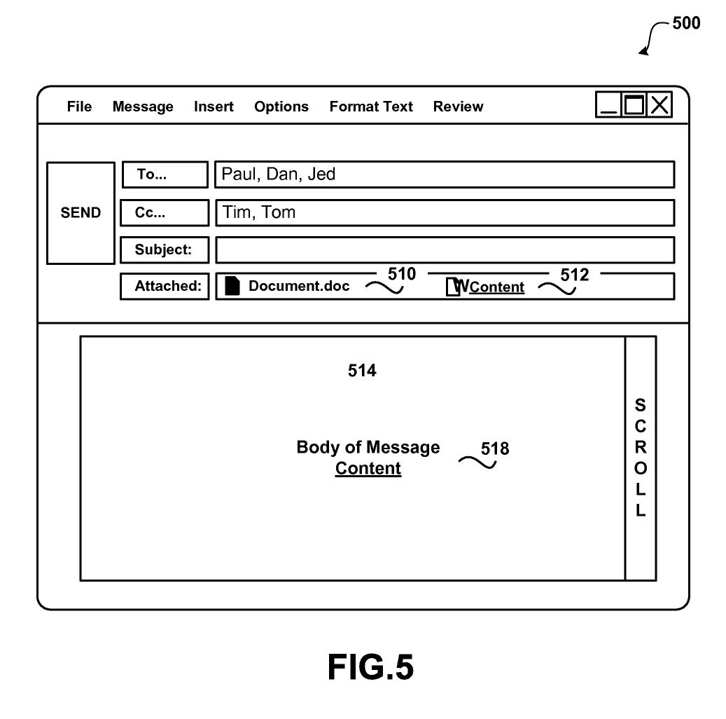

FIG. 5 shows a display of an electronic message including two links to content within a body of an electronic message. As illustrated, message 500 shows a link 518 to content within the body of the message 514. Another link (Document.doc) is included within the body of the message but is not visible within the current viewing screen. In the current example, the link to Document.doc is presented within the Attached field as downloaded content 510 and the link to content is presented as a link to the content 512 within the Attached field. According to an embodiment, the user may view an icon that is associated with the link to determine a type of content and whether or not the content has been downloaded. In this case, the icon is colored black indicating that the content has been downloaded. Content 512 is a link to Web content as indicated by the “W” that is displayed with the web content. Other indicators may be used to associate a status/content type with the link (e.g. different colors, icons, patterns, and the like).

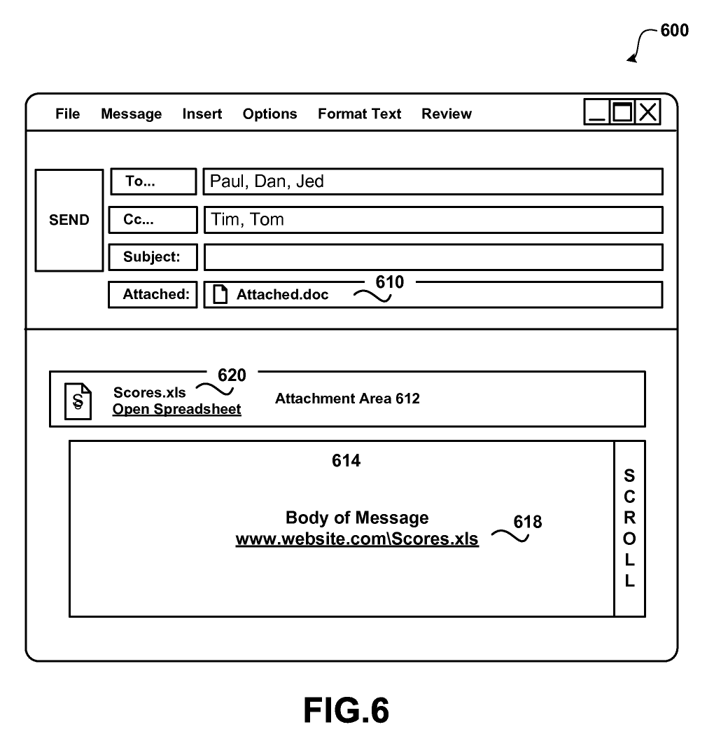

FIG. 6 shows a display of an electronic message including a link to content within a body of an electronic message and an attached document. As illustrated, message 600 shows a link 618 to content within the body of the message 614 and an attached document (Attached.doc) 610 that is not associated with a link in the body of the message. In the current example, the link to the spreadsheet 618 that is included within the body of the message is displayed within a different attachment area 612 as compared to the attached document in order to provide a way to differentiate between attached documents and linked content. The linked content may also be displayed within the Attached field.

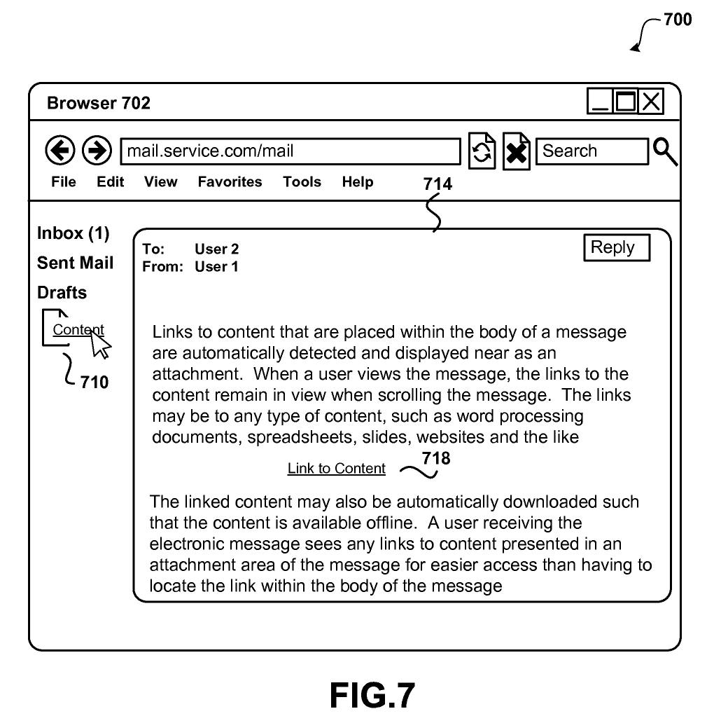

FIG. 7 shows a display of an electronic message within a Web browser including a link to content within a body of an electronic message. As illustrated, Web browser 702 shows message 714 that includes a link 718 to content. The link to the content 718 that is included within the body of the message is displayed in a consistent location within the browser 702 such that the linked content may easily be found. In the current example, the linked content 710 is shown beneath the menu options relating to the current message. The linked content may also be displayed in other areas outside of the body of the message.

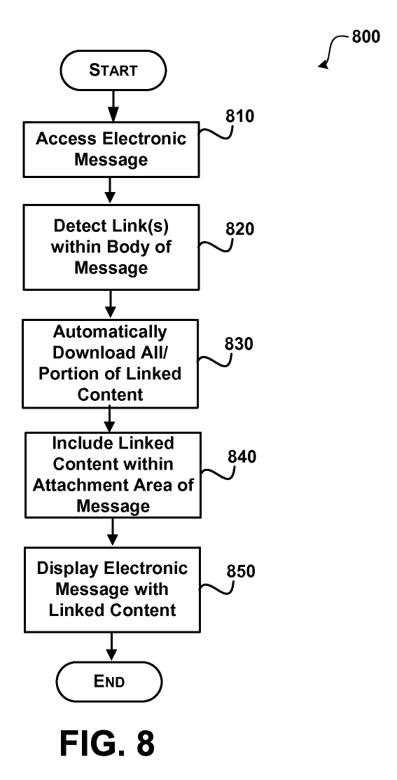

FIG. 8 shows an illustrative process for presenting links to content as attachments in electronic messages. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof

After a start block, process 800 moves to operation 810, where the electronic message is accessed. The electronic message may be any electronic message that includes a link within the body of the message. According to an embodiment, the electronic messages are email messages. Other messages may also include links, such as SMS, MMS, Instant Messages, social network messages, and the like.

Flowing to operation 820, any links that are contained within the body of the electronic message are detected. The detection may occur before the message is sent and/or after the message is sent. For example, when a message is received, the message may be automatically parsed to detect the links that are included within the body of the message. The links may be contained anywhere within a thread of the electronic message (e.g. within a first reply to a message, a third reply and the original message).

Moving to operation 830, the linked content may be automatically downloaded. According to an embodiment, content that is linked within the body of the message is automatically downloaded and displayed within the attachment area before the user receiving the message views the message. The linked content may be obtained before the message is sent and/or after the message is received by the user. For example, upon receipt of the message, the linked content may be automatically downloaded and included with the message. All/some of the linked content may be automatically downloaded. For example, the linked content may be automatically downloaded based on predetermined conditions, such as: the message is from a trusted sender, the size of the linked content is below a size threshold, the link is included within a reply message to the receiver of the message, the message originates from a specified source, and the like

Transitioning to operation 840, the linked content is included within an attachment area of the message. The attachment areas may be presented within many different areas of the display. Generally, the attachment area is located such that the display of the attached area remains visible even though the body of the message may be scrolled to change the view of the message. For example, the attachment area may be located near the To:/From: fields, near a position around the body of the message, and/or in some other location around the message. According to an embodiment, the linked content is displayed where other attachments for the message are displayed. The linked content may also be displayed in a location of the message separate from the display of the attached content (e.g. a separate attachment area). A graphical indicator, such as an icon, may also be displayed within the linked content in the attachment area to indicate a type of the content and whether or not the content has been automatically downloaded. For example, an icon may be displayed to represent that the content is a document and that the document has been automatically downloaded.

Flowing to operation 850, the electronic message is displayed with the linked content in an attachment area of the electronic message. When a user views the message, the linked content remains in a same position relative to the message when scrolling the body of the message.

The process then flows to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for presenting links to content within a body of an electronic message as attachments, comprising:
detecting a link to content within a body of an electronic message;
including the linked content within an attachment area of the electronic message such that when the body of the electronic message is scrolled, the linked content within the attachment area remains within view; and
displaying the electronic message that includes the linked content within the attachment area of the electronic message.

2. The method of claim 1, further comprising automatically downloading the linked content before the electronic message is displayed.

3. The method of claim 1, further comprising automatically synchronizing changes made to the linked content while offline when a connection is established with a server storing the content.

4. The method of claim 1, wherein displaying the linked content within the attachment area of the electronic message comprises placing the linked content near a top of the electronic message.

5. The method of claim 1, wherein displaying the linked content within the attachment area of the electronic message comprises displaying the linked content as an attachment to the electronic message.

6. The method of claim 1, wherein displaying the linked content within the attachment area of the electronic message comprises displaying the linked content as an attachment to the electronic message and selecting an icon to represent the attachment based on a type of the linked content.

7. The method of claim 1, wherein displaying the linked content within the attachment area of the electronic message comprises also displaying the link to the content within the body of the electronic message.

8. The method of claim 1, wherein detecting the link to content within the body of an electronic message occurs after the electronic message is received.

9. The method of claim 1, further comprising before downloading the content determining when the linked content is from at least one of: a trusted sender; a size of the linked content is below a predetermined size.

10. A computer-readable storage medium storing computer-executable instructions for presenting links to content within a body of an electronic message as attachments, comprising:
detecting a link to content within a body of an electronic message;
including the linked content within an attachment area of the electronic message such that when the body of the electronic message is scrolled, the linked content within the attachment area remains statically positioned relative to a display of the electronic message;
determining when to automatically download the linked content before the electronic message is displayed; and
displaying the electronic message that includes the linked content within the attachment area of the electronic message.

11. The computer-readable storage medium of claim 10, further comprising automatically synchronizing changes made to the linked content while offline.

12. The computer-readable storage medium of claim 10, wherein displaying the linked content within the attachment area of the electronic message comprises displaying the linked content as an attachment to the electronic message.

13. The computer-readable storage medium of claim 10, wherein displaying the linked content within the attachment area of the electronic message comprises displaying the linked content as an attachment to the electronic message and selecting an icon to display with the linked content to represent the attachment based on a type of the linked content.

14. The computer-readable storage medium of claim 10, wherein detecting the link to content within the body of an electronic message and automatically downloading the linked content occurs after the electronic message is received.

15. The computer-readable storage medium of claim 10, further comprising before downloading the content determining when the linked content is from at least one of: a trusted sender; a size of the linked content is below a predetermined size.

16. A system for presenting links to content within a body of an electronic message as attachments, comprising:
a network connection that is configured to connect to a network;
a processor, memory, and a computer-readable storage medium;
an operating environment stored on the computer-readable storage medium and executing on the processor;
a messaging application; and
a link manager operating in conjunction with the messaging application that is configured to perform actions comprising:
detecting a link to content within a body of an electronic message that is received by the messaging application;
including the linked content within an attachment area of the electronic message such that when the body of the electronic message is scrolled, the linked content within the attachment area remains statically positioned relative to a display of the electronic message;
determining when to automatically download the linked content before the electronic message is displayed; and
displaying the electronic message that includes the linked content within the attachment area of the electronic message.

17. The system of claim 16, further comprising automatically synchronizing changes made to the linked content while offline.

18. The system of claim 16, wherein displaying the linked content within the attachment area of the electronic message comprises displaying the linked content as an attachment to the electronic message and selecting an icon to display with the linked content to represent the attachment based on a type of the linked content.

19. The system of claim 16, wherein detecting the link to content within the body of an electronic message and automatically downloading the linked content occurs after the electronic message is received.

20. The system of claim 16, further comprising before downloading the content determining when the linked content is from at least one of: a trusted sender; a size of the linked content is below a predetermined size.
